(19) United States
(12) Patent Application Publication
(10) Pub. No.: US 2022/0092761 A1
(43) Pub. Date: Mar. 24, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Tadao MICHIMURA, Kanagawa (JP); Naoyuki ENOMOTO, Kanagawa (JP); Masayuki YAMAGUCHI, Kanagawa (JP)

(73) Assignee: FUJIFILM Business Innovation Corp., Tokyo (JP)

(21) Appl. No.: 17/163,542

(22) Filed: Jan. 31, 2021

(30) Foreign Application Priority Data
Sep. 23, 2020 (JP) 2020-158347

(51) Int. Cl. G06T 7/00; G06K 9/00; G06K 9/46; G06K 9/42; G06K 9/54; G06F 30/27

(52) U.S. Cl. CPC G06T 7/0002; G06K 9/00476; G06K 9/46; G06T 2207/20081; G06K 9/54; G06F 30/27; G06T 2207/30168; G06K 9/42

(57) ABSTRACT

An information processing apparatus includes: a memory storing, in an associated form, part identification information and information on at least one drawing; and a processor configured to receive an image of a drawing, read part identification information from the image, retrieve from the memory the information on the at least one drawing associated with the part identification information read from the image, extract a feature from the image, evaluate a quality of the received drawing by inputting the extracted information on the at least one drawing and the feature to artificial intelligence that has learned to evaluate drawings through machine learning, and display evaluation results of the received drawing on a display.

### CROSS-REFERENCE TO RELATED APPLICATIONS

This application is based on and claims priority under 35 USC 119 from Japanese Patent Application No. 2020-158347 filed Sep. 23, 2020.

### BACKGROUND

### (i) Technical Field

The present disclosure relates to an information processing apparatus and a non-transitory computer readable medium.

### (ii) Related Art

Japanese Unexamined Patent Application Publication No. 2017-084224 discloses a design assisting apparatus, program, and design assisting method. The design assisting apparatus, program, and design assisting method address quick creation and presentation of a design plan for products including an unexperienced product in response to a new request of a customer. Along with relate-art simulation or design assisting system using part information database of products, the design assisting apparatus estimates a customer request to a target product using the customer request to a similar product, performs simulation using an analysis model that is capable of evaluating a request item responsive to the estimated customer request, creates a product system design plan, and associates the created system design plan with the design item.

Japanese Unexamined Patent Application Publication No. 2019-095217 discloses a visual inspection apparatus that flexibly inspects a shape and a new fault mode of an inspection target. The visual inspection apparatus includes a data combination creation unit. In accordance with a reference data set and a learning data set, the data combination creation unit selects from respectively different data sets a first image serving as an image of a normal product and a second image of an image of a product serving as a comparison and creates a combination. The visual inspection apparatus further includes a machine learning device that learns to sort the product corresponding to the second image in terms of whether the product corresponding to the second image is normal or faulty. The machine learning device includes a state observation unit, a label data acquisition unit, and a learning unit. The state observation unit observes the combination of the first image and the second image as a state variable representing the present state of an environment. The label data acquisition acquires as label data a label attached to the second image. The learning unit performs learning by associating the state variable with the label data.

Japanese Unexamined Patent Application Publication No. 2016-122293 discloses drawing inspection assisting apparatus and method. The drawing inspection assisting apparatus and method address the detection of an omission of size description of each element in a two-dimensional (2D) design drawing created from a three-dimensional (3D) model. The drawing inspection assisting apparatus extracts a production log and an attribute item of each production log of the 3D model serving as the base of the 2D design drawing serving as an inspection target. The drawing inspection assisting apparatus sets the number of attribute items excluding an attribute item whose size is free from being described on the 2D design drawing serving as the inspection target to be a size description necessity count of the 2D design drawing serving as the inspection target. The drawing inspection assisting apparatus compares the size description necessity count with an actual size description count that is a total number of sizes described on the 2D design drawing serving the inspection target to determine whether the actual size description count is excessive or deficient. The drawing inspection assisting apparatus thus outputs the determination results.

Part detection technique is disclosed in the article entitled “Application of Artificial Technology in Product Design,” Nozaki et., FUJITSU. 67, 3, p. 58-65 (05, 2016), https://www.fujitu.com/jp/documents/about/resources/publications/magazine/backnumber/vol67-3/paper 10.pdf. According to the disclosure, a part having a higher similarity to a past part is detected in order to predict the number of layers of a board in accordance with circuit design information by using a learning model created by a support vector machine and in order to automatically detect a part of a 3D model in structural design.

Simulators are typically used in a verification phase of designing. Simulators are appropriate for discovering a faulty logic but have difficulty in evaluating the quality of a drawing.

### SUMMARY

Aspects of non-limiting embodiments of the present disclosure relate to providing an information processing apparatus and non-transitory computer readable medium evaluating the quality of a drawing.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided An information processing apparatus including: a memory storing, in an associated form, part identification information and information on at least one drawing; and a processor configured to receive an image of a drawing, read part identification information from the image, retrieve from the memory the information on the at least one drawing associated with the part identification information read from the image, extract a feature from the image, evaluate a quality of the received drawing by inputting the extracted information on the at least one drawing and the feature to artificial intelligence that has learned to evaluate drawings through machine learning, and display evaluation results of the received drawing on a display.

### BRIEF DESCRIPTION OF THE DRAWINGS

Exemplary embodiment of the present disclosure will be described in detail based on the following figures, wherein:

FIG. 1 illustrates a conceptual modular configuration of a structure of the exemplary embodiment;

FIGS. 2A and 2B illustrate a system configuration of the exemplary embodiment;

FIG. 3 is a flowchart illustrating a process example of the exemplary embodiment;

FIG. 4 illustrates a process example of the exemplary embodiment;

FIG. 5 illustrates an example of a data structure of a drawing information table;

FIG. 6 illustrates a data structure of a term table of the exemplary embodiment;

FIGS. 7A through 7D illustrate process examples of the exemplary embodiment;

FIGS. 8A and 8B illustrate process examples of the exemplary embodiment;

FIG. 9 is a graph illustrating a relationship between the number of NONASSYs on a drawing and the complexity of a circuit;

FIGS. 10A and 10B illustrate a process example of the exemplary embodiment; and

FIG. 11 is a flowchart illustrating a process example of the exemplary embodiment.

### DETAILED DESCRIPTION

An exemplary embodiment of the disclosure is described below.

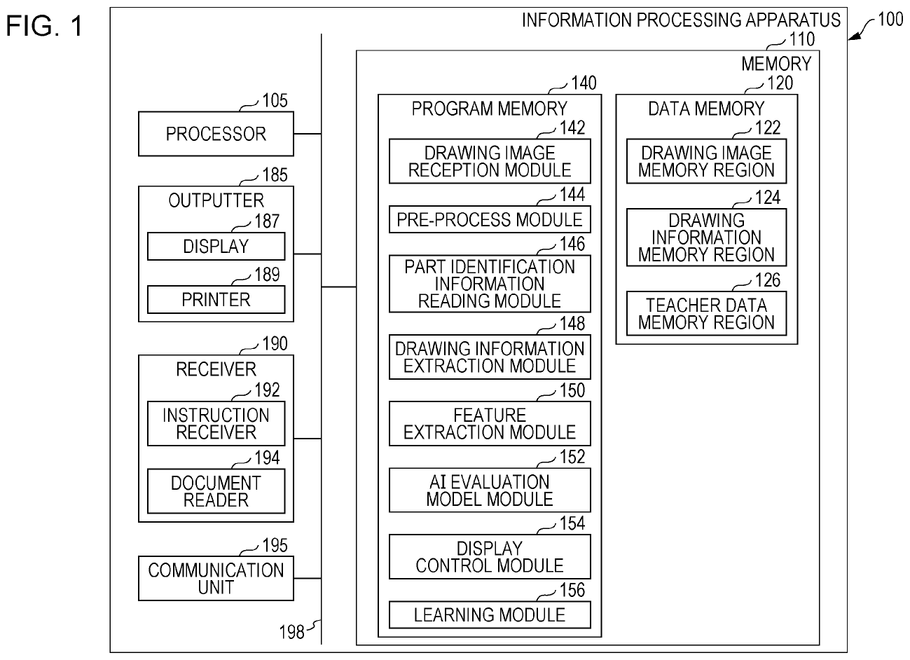

FIG. 1 a conceptual modular configuration of a structure of the exemplary embodiment.

The term “module” refers to a software part (including a computer program) that is logically separable, or a hardware part. The module of the exemplary embodiment refers to not only a module in a computer program but also a module in a hardware configuration. The discussion of the exemplary embodiment also serves as the discussion of a system, method, and computer program that causes the modules to function (including a program that causes a computer to execute each step, a program that causes the computer to function as an element, and a program that causes the computer to implement each function). In the discussion that follows, the phrases “stores information,” “causes information to be stored,” and other phrases equivalent thereto are used. If the exemplary embodiment is a computer program, these phrases are intended to express “causes a memory device to store information” or “controls a memory device to cause the memory device to store information.” The modules may correspond to the functions in a one-to-one correspondence. In software implementation, one module may be configured of one program or multiple modules may be configured of one program. One module may be configured of multiple programs. Multiple modules may be executed by a single computer. A single module may be executed by multiple computers in a distributed environment or a parallel environment. One module may include another module.

In the discussion that follows, the term “connection” refers to not only a physical connection but also a logic connection (such as an exchange of data, instructions, data reference relationship, or login).

The term “predetermined” means that something is decided in advance of a process of interest. The term predetermined is thus intended to refer to something that is decided in advance of a process of interest in the exemplary embodiment. Even after a process in the exemplary embodiment has started, the term predetermined refers to something that is decided in advance of a process of interest depending on a condition or a status of the exemplary embodiment at the present point of time or depending on a condition or status of the exemplary embodiment heretofore continuing down to the present point of time. If plural predetermined values are used, the predetermined values may be different from each other, or two or more of the predetermined values (including all the values) may be equal to each other.

A statement that “if A, B is to be performed” is intended to mean that a determination as to whether something is A is performed and that if something is determined as A, an action B is to be taken. The statement becomes meaningless if the determination as to whether something is A is not performed. If a discussion is made of events “A, B, and C,” the discussion is applicable to at least one of the events “A, B, and C” unless otherwise noted. For example, the discussion is applicable to the case in which only the event A is selected.

The term “system” or the term “apparatus” refers to an arrangement where multiple computers, a hardware configuration, and an apparatus are interconnected via a communication network (including a one-to-one communication connection). The term system or the term apparatus also refers to an arrangement that includes a single computer, a hardware configuration, and an apparatus. The term system and the term apparatus have the same definition and are interchangeable with each other. The system in the context of the exemplary embodiment does not include a social system that is a social arrangement formulated by humans.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate.

The information processing apparatus 100 of the exemplary embodiment has a function of evaluating the quality of a drawing. Referring to FIG. 1, the information processing apparatus 100 includes, at least, a processor 105, memory 110 and bus 198 that connects these elements to exchange data. The information processing apparatus 100 may further include an outputter 185, receiver 190, and communication unit 195. Data is also exchanged via the bus 198 from one to another element among the processor 105, memory 110, outputter 185, receiver 190, and communication unit 195. The evaluation of the quality of the drawing is performed as a drawing check process or one step of the drawing check process.

The block diagram in FIG. 1 also indicates a hardware configuration of a computer that implements the exemplary embodiment. The hardware configuration of the computer that executes a program of the exemplary embodiment is a computer illustrated in FIG. 1. Specifically, the hardware configuration is a personal computer or a computer that may be used as a server. Specifically, the processor 105 and memory 110 are used as a processing unit and a storage device, respectively.

One or more processors 105 may be used. The processor 105 may include a central processing unit (CPU) or a microprocessor. If multiple processors 105 are used, they are tightly coupled or loosely coupled. For example, a single processor 105 may include multiple processor cores. Multiple computers are coupled as a system that virtually functions as a single computer. Specifically, a loosely coupled multi-processor may be configured as a cluster system or a computer cluster. The processor 105 executes a program on a program memory 140.

The memory 110 may include a semiconductor memory, such as a register or a cache memory, in the processor 105 or a memory, such as a random-access memory (RAM) or a read-only memory (ROM). The memory 110 may also be an internal memory device, such a hard disk drive (HDD) or a solid-state drive (SSD), each functioning as a persistent memory, or an external memory device or an auxiliary memory device, such as a compact disc (CD), or digital versatile disc (DVD), Blu-ray (registered trademark) disc, universal serial bus (USB) memory, memory card or other external storage device or other auxiliary memory device. The memory 110 may also be a memory device of a server connected to the information processing apparatus 100 via a communication network.

The memory 110 includes a data memory 120 storing data and a program memory 140 storing programs. The data memory 120 and the program memory 140 may store programs of the modules illustrated in FIG. 1, programs such as an operating system to start up the computer, and data, such as parameters that appropriately vary in the execution of the modules.

The outputter 185 includes a display 187 and printer 189. The display 187 may be a liquid-crystal display, organic electroluminescent (EL) display, three-dimensional display, or projector and displays, in text or image, process results from the processor 105 and data on the data memory 120. The printer 189 may be a printer or a multi-function device and prints the process results from the processor 105 and data on the data memory 120. The outputter 185 may also include a speaker and actuator to vibrate the outputter 185.

The receiver 190 includes an instruction receiver 192 and a document reader 194. The instruction receiver 192 includes a keyboard, mouse, microphone, camera (including eye-gaze detection camera) or other device and receives data generated in response to user operation performed on these device (such as an action, voice, gaze of a user).

A touch screen serving the functions of both the display 187 and the instruction receiver 192 may be used. In such a case, without the physical presence of keys, the keyboard function may be implemented by drawing a keyboard (called a software keyboard or a screen keyboard) on the touch screen using software.

A display 187 and instruction receiver 192 are used as user interfaces.

The document reader 194, such as a scanner or camera, reads or photographs a document to create image data. The document reader 194 may be a flatbed scanner, sheet-through scanner, or overhead scanner to read a drawing.

The communication device 195 is a communication network interface used to connect to another apparatus via a communication network.

The exemplary embodiment related to a computer program is implemented when the computer program as software is read onto the program memory 140 as a hardware resource and the software and hardware cooperate with each other.

Specifically, to implement the exemplary embodiment, information processing based on software is performed by hardware resources (at least including the processor 105 and the memory 110 and in some cases further the outputter 185, receiver 190, and communication unit 195). The exemplary embodiment is thus implemented in accordance with the laws of nature.

The hardware configuration in FIG. 1 is illustrated for exemplary purposes only. The exemplary embodiment is not limited to the configuration illustrated in FIG. 1 and is acceptable as long as the configuration implements the modules of the exemplary embodiment. For example, the processor 105 may include a graphics processing unit (GPU) (including general-purpose computing on graphics processing unit (GPGPU)). Part of the modules may be implemented by a dedicated hardware resource (such as application specific integrated circuit (ASIC)) or field-programmable gate array (FPGA) that is a reconfigurable integrated circuit. Part of the modules may be in an external system that is connected via a communication network. Multiple of the system in FIG. 1 may be operatively coupled via a communication network. The system in FIG. 1 may be incorporated in a personal computer, portable information communication apparatus (such as cellular phone, smart phone, mobile device, or wearable computer), information appliance, robot, copier, fax, scanner, printer, or multi-function apparatus (an image processing apparatus having at least two of scanner function, printer function, copier function, and fax function).

The processor 105 is connected to the memory 110, outputter 185, receiver 190, and communication device 195 via the bus 198. The processor 105 executes a process in accordance with the computer program that describes an execution sequence of each module and stored on the program memory 140. For example, in response to an event when the instruction receiver 192 receives user operation, the processor 105 performs the process of a module responsive to the event on the program memory 140, causes the data memory 120 to store the process results, outputs the process results to the display 187, or transmits the process results to another apparatus by controlling the communication device 195.

The memory 110 includes the data memory 120 and program memory 140 and is connected to the processor 105, outputter 185, receiver 190, and communication device 195 via the bus 198.

The data memory 120 includes a drawing image memory region 122, drawing information memory region 124, and teacher data memory region 126.

The drawing image memory region 122 stores the image of a drawing received by a drawing image reception module 142. The image of the drawing is a binary image, gray-scale image or color image. If the image is a gray-scale image or color image, it may be converted into a binary image.

The drawing information memory region 124 stores part identification information on a drawing and information on the drawing.

The part identification information is used to uniquely identify a part whose structure is used for the information processing apparatus 100 to uniquely identify the part in a target drawing. The part may include a part including multiple components and also include a finished product. For example, in an electrical circuit drawing, the part may be a single board, integrated circuit (IC) chip, or system. In a mechanical drawing, the part may be a basic component, a module including multiple parts, and a product. The part identification information may also be a part number that uniquely identifies a part in the exemplary embodiment.

The information on the drawing is information indicating the quality of the drawing. More in detail, the information indicating the quality of the drawing includes at least one piece of information selected from a group including a version number of the drawing, a number of checkers who has checks the drawing, a number of days from the start of the creation of the drawing to the end of the check of the drawing, and a degree of importance of the drawing. The version number of the drawing, the number of checkers who has checked the drawing, the number of days from the start of the creation of the drawing to the end of the check of the drawing, and the degree of importance of the drawing are information indicating the quality of a target drawing. A drawing that has been used without being modified for a long period of time, a drawing having a large number of viewers involved, and a drawing having a long life have typically a high quality.

The teacher data memory region 126 stores information that serves as teacher data in machine learning of artificial intelligence (AI) that is used to create an AI evaluation model module 152. Besides learning data created in advance, the teacher data memory region 126 may store evaluation results obtained by the AI evaluation model module 152 and evaluation results obtained by human. For example, if valuation results obtained by the AI evaluation model module 152 are different from evaluation results obtained by human, learning data that is used to learn to correct the evaluation results obtained by the AI evaluation model module 152 may be stored.

The program memory 140 includes a drawing image reception module 142, pre-process module 144, part identification information reading module 146, drawing information extraction module 148, feature extraction module 150, AI evaluation model module 152, display control module 154, and learning module 156.

In response to the reception of the image of a drawing, the drawing image reception module 142 transfers the image to another module. The reception of the image includes an operation in which the document reader 194, such as a scanner or a camera, reads the image, an operation in which a fax machine reads the image from an external device via a communication network, and an operation in which the image is read from a hard disk (built in a computer or connected via a network). One or more images may be received.

The pre-process module 144 deletes information other than on the part from the drawing received by the drawing image reception module 142.

The information other than on the part is information on anything other than the part described on the target drawing. For example, the information other than on the part may be change notices, notes, leaders, guides, frame borders, logs, copyright notices, and change points.

If the drawing received by the drawing image reception module 142 is a resin drawing or sheet metal drawing, the pre-process module 144 may normalized the image of the drawing in a pre-process.

The part identification information reading module 146 reads the part identification information from the image. The target image herein may be an image received by the drawing image reception module 142 or an image pre-processed by the pre-process module 144.

The drawing information extraction module 148 retrieves from the drawing information memory region 124 the information on the drawing corresponding to the part identification information.

The feature extraction module 150 extracts a feature from the image. The target image herein may be an image received by the drawing image reception module 142 or an image pre-processed by the pre-process module 144 (the image obtained by the pre-process module 144 in the pre-process).

The feature extraction module 150 may extract as the feature at least one piece of information selected from a group including a product name, sheet number, the number of all sheets, and the number of approvers (with no duplication).

If the target drawing is an electrical circuit part drawing, the feature extraction module 150 may extract, as the feature to be extracted from the image, at least one piece of information selected from a group including a notation indicating acceptability of future mounting and information on an electrical part.

The notation indicating the acceptability of future mounting is typically referred to “NONASSY.” The notation represents a portion of the drawing that has through-holes with no part still mounted thereon. Such portion may possibly be arranged for future design changes. For example, a design engineer arranges through-holes to minimize the impact of a design change.

The feature extraction module 150 may extract as the feature an image that results when the pre-process module 144 performs the pre-process to delete an unwanted element from the image received by the drawing image reception module 142. The feature herein may be an image subsequent to the pre-process (such as a binary image) or information extracted from the image subsequent to the pre-process (such as recognition results of a part or correction point from a drawing having a preceding version number). For example, the feature extraction module 150 may extract, as the feature, information that is described within the image and determined from the information on the drawing in the image received by the drawing image reception module 142.

If the drawing is a resin drawing or sheet metal drawing, the feature may be a value indicating the complexity of an element in the drawing. Specifically, the feature may be (peripheral length×peripheral length/area). If the feature is (peripheral length×peripheral length/area), the pre-process module 144 normalizes beforehand the size of the drawing and resolution of the drawing in a normalization operation. Specifically, the pre-process module 144 expands or reduces the image of the received drawing to a predetermined size or resolution.

The AI evaluation model module 152 evaluates the quality of the drawing, received by the drawing image reception module 142, by inputting the information on the image and feature to the AI that has learned beforehand to evaluate drawings through machine learning.

The evaluation of the quality refers to the determination of the level of completion of the target drawing or conversely the determination of the possibility of modification of the drawing. For example, the target drawing is determined in terms of the following points of view: whether the target drawing is a completion drawing, whether the target drawing is to be checked in a review meeting, whether the target drawing is to be corrected, and further whether an amendment is to be proposed to the target image.

The display control module 154 performs control to display evaluation results of the drawing on the display 187.

The learning module 156 performs machine learning using teacher data stored on the teacher data memory region 126 in order to create the AI evaluation model module 152. In order to increase the quality of the evaluation of the AI evaluation model module 152, further machine learning may be performed. If the evaluation results obtained by the AI evaluation model module 152 are different from the evaluation results obtained by human as described above, machine learning may be performed to correct the evaluation results of the AI evaluation model module 152.

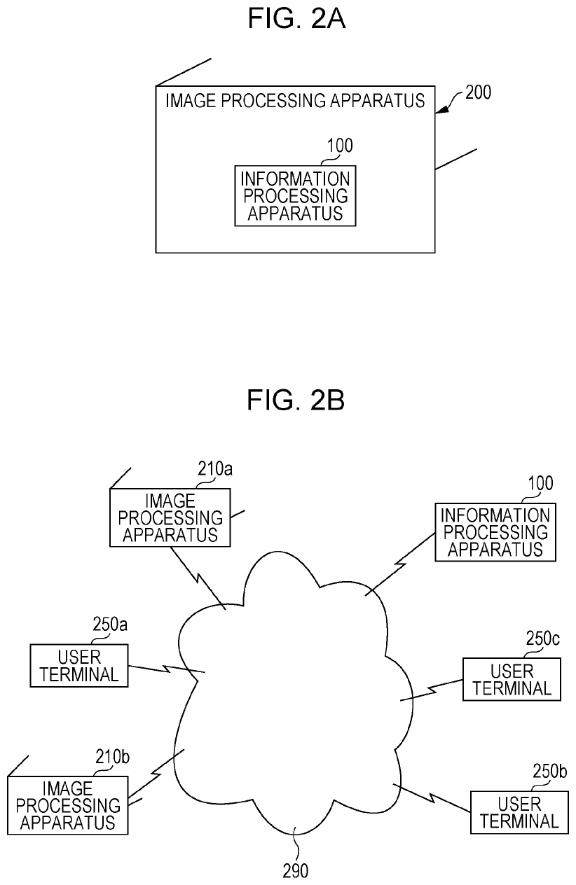

FIGS. 2A and 2B illustrate a system configuration of the exemplary embodiment.

FIG. 2A illustrates an example in which the exemplary embodiment is configured as a standalone system.

An image processing apparatus 200 includes the information processing apparatus 100. The information processing apparatus 100 evaluates the quality of the drawing read by the image processing apparatus 200.

FIG. 2B illustrates a network-type system of the exemplary embodiment.

An information processing apparatus 100, image processing apparatuses 210a and 210b, and user terminals 250a, 250b, and 250c are interconnected to each other via a communication network 290. The communication network 290 may be a wired network, a wireless network, or a combination thereof. For example, the communication network 290 may be the Internet or intranet as a communication infrastructure. The function of the information processing apparatus 100 may be implemented as a cloud service. For example, the image processing apparatus 210 reads a drawing, and the information processing apparatus 100 evaluates the quality of the drawing in response to an instruction of a user of the user terminal 250 and transmits the evaluation results to the user terminal 250 to display them to the user.

Drawing check is performed to reduce design errors. In the drawing check, experts who have sufficient experience and knowledge in design study the drawing to determine whether any problem has occurred in terms of function, performance, intensity, and other characteristics. Transfer of knowledge through word-of-mouth is sometimes difficult possibly because of declining birthrate and aging population or declining working population. Keeping up the quality is also sometimes difficult because of complexity and diversity of products. The importance of a drawing check process is thus increasing.

The information processing apparatus 100 of the exemplary embodiment evaluates the quality of the drawing through the AI.

There are following circumstances in the electrical circuit part drawings.

With the advance of the simulators of electrical circuits, irregularities, such as electrical noise or delay, are calculated in a design phase and addressed beforehand. The number of modifications of the drawing due to such irregularities is reduced after the issue of the electrical circuit part drawing. However, the environmental setting may be complex or a person in charge may be in a hurry in using a simulator and the verification through the simulator may be insufficient. As a result, irregularities occur. Initial design specifications may be changed because of cost reduction and the accuracy level of a part, such as a capacitor, may be varied. In view of such events the simulator is unable to verify, the possibility of the drawing change increases.

A model that has learned the change log of the electrical circuit part drawing is produced and a newly designed electrical circuit part drawing is scanned and evaluated through machine learning. The quality of the new electrical circuit part drawing is presented such that a person reviews again the new electrical circuit part drawing in accordance with the quality or input the new electrical circuit part drawing to the simulator.

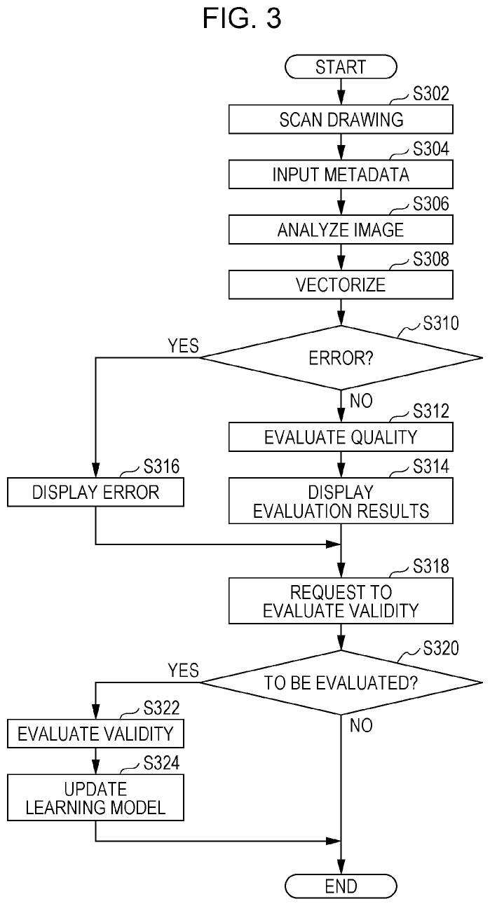

FIG. 3 is a flowchart illustrating a process example of the exemplary embodiment.

In step S302, a drawing is scanned.

In step S304, metadata is input as the information on the drawing scanned. For example, the metadata may be the phase of the drawing. The phases may include a draft phase, issued version phase, and post-market-introduction phase. The operation in step S304 may be omitted.

In step S306, the image of the drawing is analyzed. The pre-process is performed to delete an unwanted element from the image of the drawing. If the drawing is a resin drawing or sheet metal drawing, the image of the drawing is normalized in the pre-process. Specifically, the sizes of the drawings is matched to a predetermined size. For example, the drawing may be expanded or reduced to a sheet size A0.

In step S308, a vectorization operation is performed on the pre-processed image. The pre-processed image is thus vectorized.

In step S310, a determination as to whether an error has occurred is made. If an error has occurred, the process proceeds to step S316; otherwise, the process proceeds to step S312.

In step S312, the quality of the drawing is evaluated by using an artificial intelligence (AI) model.

In step S314, evaluation results are displayed.

In step S316, an indication that an error has occurred is displayed.

In step S318, a request is made to the expert as to whether to evaluate the validity of the quality obtained in step S312.

In step S320, a determination is made as to whether the validity of the quality is to be evaluated by the expert. If the yes path is followed, the process proceeds to step S322; otherwise, the process ends.

In step S322, the validity is evaluated. The validity evaluation by the expert may be an evaluation as valid (indicating that the evaluation of the AI model agrees with the evaluation by the expert), an evaluation as not valid (indicating that the evaluation of the AI model fails to agree with the evaluation by the expert), or an evaluation somewhere therebetween.

In step S324, the AI model is updated. Machine learning is performed in accordance with the evaluation results in step S322. For example, if the evaluation indicates that the validity evaluation by the expert is valid, machine learning increasing the evaluation trend is not performed or machine learning is not performed at all. If the evaluation indicates that the validity evaluation by the expert is not valid, machine learning is performed such that the evaluation by the AI model approaches the evaluation by the expert.

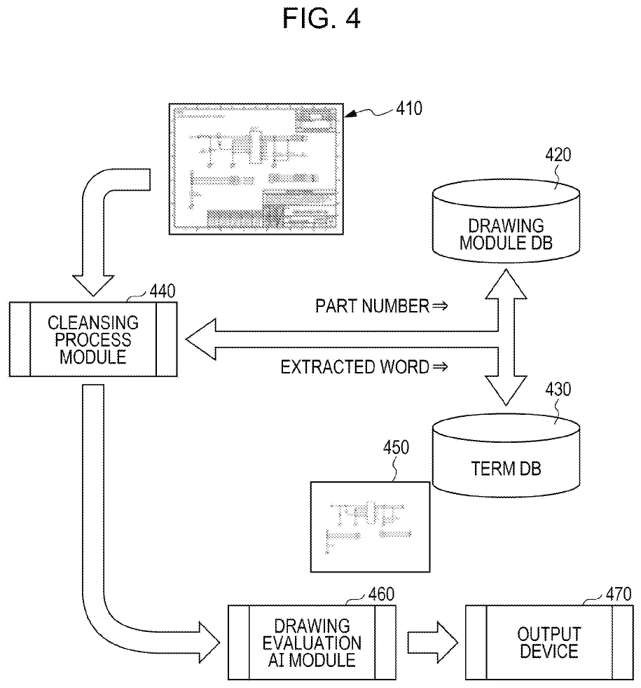

FIG. 4 illustrates a process example of the exemplary embodiment.

A cleansing process module 440 corresponds to the drawing image reception module 142, pre-process module 144, part identification information reading module 146, drawing information extraction module 148, and feature extraction module 150 illustrated in FIG. 1. A drawing evaluation AI module 460 corresponds to the AI evaluation model module 152 illustrated in FIG. 1. An output device 470 corresponds to the display control module 154 illustrated in FIG. 1.

The cleansing process module 440 is connected to a drawing module DB 420, term DB 430, and drawing evaluation AI module 460. The cleansing process module 440 receives a drawing image 410. Not only a circuit diagram but also a variety of metadata and a guide helping read the metadata are typically described on the drawing.

The cleansing process module 440 reads a part number on the drawing image 410 (an example of the part identification information) and retrieves from the drawing module DB 420 information on the drawing image 410 (for example, a version number (the number of issues), a total number of persons who had reviewed, the number of days from the start of the development of the drawing to the end of the review of the present version, and the importance of the drawing). The cleansing process module 440 stores these pieces of information as vector data. The vector data is to be input to the drawing evaluation AI module 460.

The cleansing process module 440 reads the name of a part on the drawing image 410 and stores the name as the vector data.

The cleansing process module 440 reads a sheet number and the total number of sheets on the drawing image 410 and stores the read information as the vector data.

The cleansing process module 440 reads the unique number of approvers (the number of approvers without duplication) and stores the read number as the vector data.

The cleansing process module 440 counts the NONASSY notations, capacitors, resistors, power supplies, external connectors, wirings, switches, and diodes and stores the counted values as the vector data. The cleansing process module 440 also identifies elements in view of notation fluctuation. Specifically, the cleansing process module 440 reads terms on the drawing image 410 through character recognition and makes the recognized terms consistent a term table 600 in the term DB 430.

Specifically, the cleansing process module 440 extracts the feature from the drawing image 410 and the feature includes as the vector data the part name, sheet number, number of all sheets, unique number of approvers, number NONASSYs, number of capacitors, number of resistors, number of power supplies, number of external connectors, number of wirings, number of switches, and number of diodes.

The cleansing process module 440 deletes characters on the drawing image 410.

The cleansing process module 440 further deletes change notations (such as triangle marks), notices, leader lines and the like on the drawing image 410.

The cleansing process module 440 further deletes guides, frame borders, logs, copyright notices, change points, and the like on the drawing image 410.

The cleansing process module 440 deletes information other than on the circuit on the drawing image 410 and stores an extracted image 450 after deletion as a portion of the vector data.

The vector data thus includes (1) information retrieved from the drawing module DB 420 (information on the drawing image 410) in accordance with the part number on the drawing image 410, (2) feature extracted from the drawing image 410, and (3) extracted image 450 that results from deleting the information other than on the part from the drawing image 410. (1) The information and (2) the feature may be set to be the vector data and (3) the extracted image 450 may be excluded from the vector data.

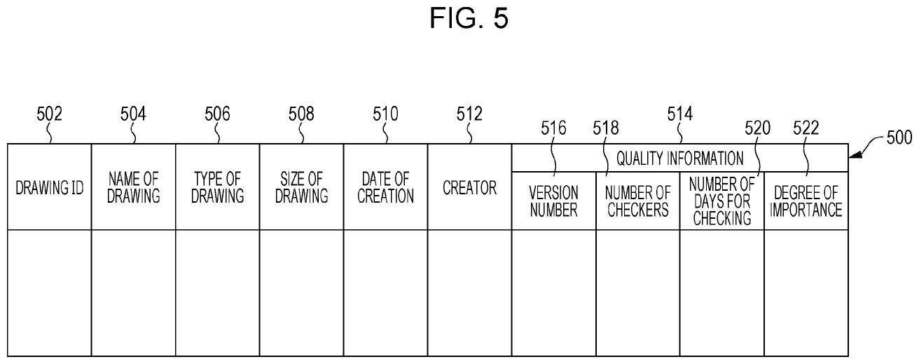

The drawing module DB 420 is connected to the term DB 430 and cleansing process module 440. The drawing module DB 420 stores, for example, a drawing information table 500. FIG. 5 illustrates a data structure of the drawing information table 500. The drawing information table 500 includes a drawing ID column 502, name of drawing column 504, type of drawing column 506, size of drawing column 508, date of creation column 510, creator column 512, and quality information column 514. The quality information column 514 includes a version number sub-column 516, number of checkers sub-column 518, number of days for checking sub-column 520, and degree of importance sub-column 522.

According to the exemplary embodiment, the drawing ID column 502 stores information uniquely identifying a drawing (specifically, a drawing identification (ID)). The name of drawing column 504 stores a name of the drawing. The type of drawing column 506 stores a type of the drawing. The information stored at the type of drawing column 506 may be, for example, a circuit diagram drawing, a resin drawing, or a sheet metal drawing. The size of drawing column 508 stores the size of the drawing, such as A0 sheet size or A1 sheet size. The date of creation column 510 stores the date of creation of the drawing. The creator column 512 stores the name of the creator of the drawing. The quality information column 514 stores the quality information on the drawing. The quality information is stored in the version number sub-column 516, number of checkers sub-column 518, number of days for checking sub-column 520, and degree of importance sub-column 522. The version number sub-column 516 stores the version number of the drawing. The number of checkers sub-column 518 stores the number of persons who have checked (total number of persons who have checked). The number of days for checking sub-column 520 stores the number of days used to check the drawing (the number of days from the start of the development of the drawing to the end of the review of the drawing). The degree of importance sub-column 522 stores the importance of the drawing. The drawing information table 500 illustrates an example of data stored on the drawing information memory region 124 in FIG. 1.

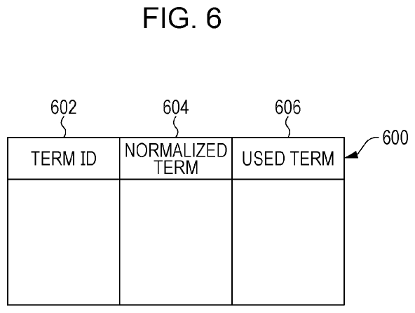

The term DB 430 is connected to the drawing module DB 420 and cleansing process module 440. The term DB 430 stores a word that is normalized to control the notification fluctuation. The term DB 430 stores, for example, a term table 600. FIG. 6 illustrates a data structure of the term table 600. The term table 600 includes a term ID column 602, normalized term column 604, and used term column 606. The term ID column 602 stores information uniquely identifying a term (specifically, a term ID) in the exemplary embodiment. The normalized term column 604 stores a normalized term. The used term column 606 stores a used term. In other words, a term stored in the normalized term column 604 is substituted for a term described in the drawing image 410 (term stored in the used term column 606) to keep the terms consistent.

The drawing evaluation AI module 460 is connected to the cleansing process module 440 and output device 470. The drawing evaluation AI module 460 is an AI model that has learned beforehand to evaluate drawings through machine learning. The vector data is input to the drawing evaluation AI module 460 to evaluate the quality of the drawing image 410.

The output device 470 is connected to the drawing evaluation AI module 460. The output device 470 outputs evaluation results provided by the drawing evaluation AI module 460.

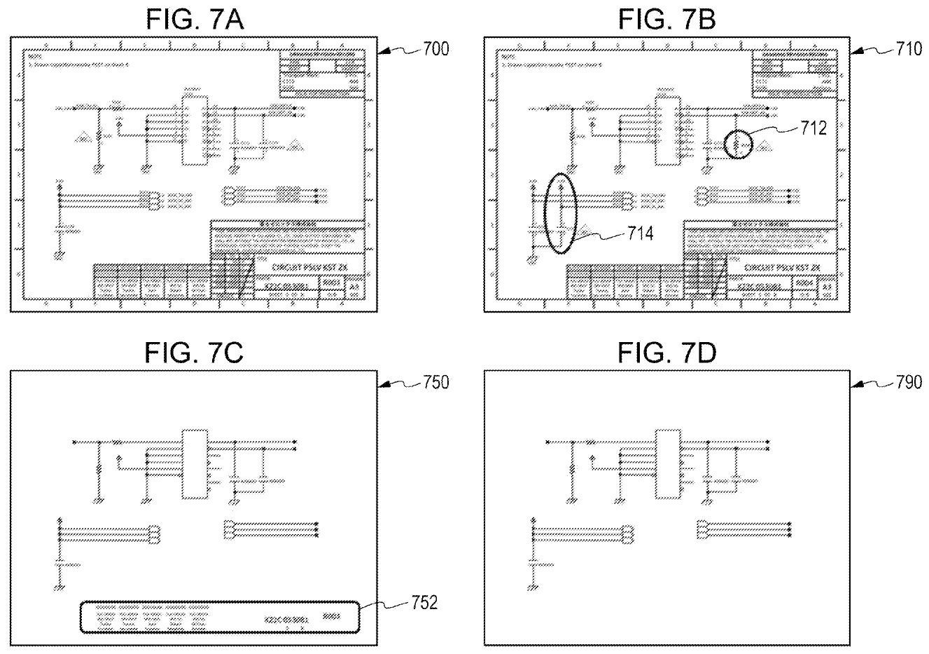

FIGS. 7A through 7D illustrate process examples of the exemplary embodiment.

A drawing image 700 in FIG. 7A and a drawing image 710 in FIG. 7B are the images of electrical circuit part drawings serving as targets. The drawing image 700 is version 1 and the drawing image 710 is a modified version (version 2). The drawing image 710 includes modification points 712 and 714 that are a difference between the drawing image 700 and the drawing image 710.

In the pre-process, a difference between a target drawing and a previous drawing (the modification points 712 and 714 in the drawing image 710) may be extracted as the feature.

An image 750 subsequent to the deletion operation illustrated in FIG. 7C is obtained by deleting an unwanted element, such as characters, from the drawing image 700. A feature portion 752 having a part name, sheet number, and the like remains on the image 750.

An extracted image 790 in FIG. 7D is obtained by further deleting the feature portion 752 from the image 750 subsequent to the deletion operation and is to be input to the drawing evaluation AI module 460.

If the drawing is an electrical circuit part drawing, the following operations may be performed in a normalization process as the pre-process.

(1) The thinnest line of a drawing having a maximum size from among all target drawings is reduced at a reduction rate at which the thinnest line is still visible. When the drawing is reduced, the drawing may be reduced without changing the line thickness by not deleting a black portion of the drawing and by deleting a white portion of the drawing with a higher priority.

(2) Expansion rate and reduction rate of each drawing is calculated with reference to the size of the drawing of the reduced maximum size. If the drawing size<the reduced maximum size, the expansion rate is calculated such that the drawing of the drawing size is expanded to the reduced maximum size.

If the drawing size the reduced maximum size, the reduction rate is calculated such that the drawing of the drawing size is reduced to the reduced maximum size.

(3) All target drawings are expanded or reduced at the expansion rate or the reduction rate, respectively.

(4) The term table 600 in the term DB 430 is referenced, a word forming a part name is replaced with a standard term, and a word, such as a project name, not present in the term table 600 is deleted.

(5) The maximum value of the metadata, such as a version number, is determined and normalized to 0 to 1. The maximum value may be a predetermined value or extracted from all target drawings. The value of the metadata, if exceeding the maximum value, is set to “1.”

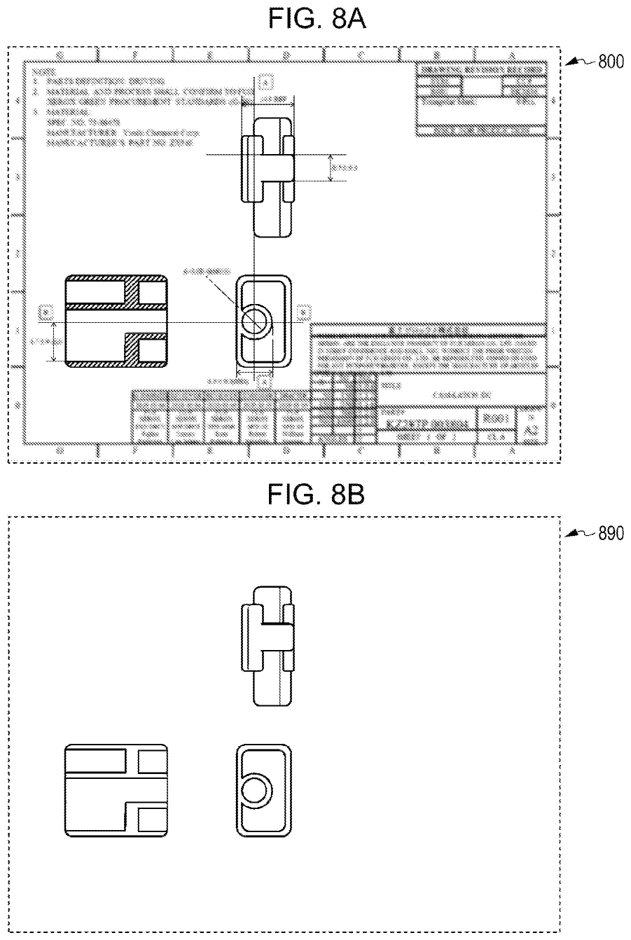

FIGS. 8A and 8B illustrate process examples of the exemplary embodiment.

A drawing image 800 in FIG. 8A is an image of a resin drawing or a sheet metal drawing serving as a target.

An extracted image 890 in FIG. 8B is obtained by performing the pre-process on the drawing image 800 and is then input to the drawing evaluation AI module 460.

In the case of the resin drawing or the sheet metal drawing, the following operations may be performed as a normalization process in the pre-process.

(1) The “complexity of the drawing” is introduced besides the feature including the number NONASSYs, number of capacitors, number of resistors, number of power supplies, number of external connectors, number of wirings, number of switches, and number of diodes on the electrical circuit part drawing. In addition, the normalization process performed on the electrical circuit part drawing is also performed. The complexity of the drawing is correlated with the number of modifications of the drawing.

(2) The “complexity of the drawing” may be, for example, (peripheral length×peripheral length/area). Alternatively, besides (peripheral length×peripheral length/area), the complexity of drawing may be Hausdroff dimension, peripheral length, number of regions, or structure. The “structure” refers to the relationship in which one region includes or is included in another region.

If (peripheral length×peripheral length/area) is used, the normalization operation of the drawing in the electrical circuit part drawing is also performed on the resin drawing or the sheet metal drawing.

In the case of the electrical circuit part drawing, the complexity of the drawing in the resin drawing or the sheet metal drawing may be included in the feature. This is because the complexity of the drawing has been proved useful in the quality evaluation of the electrical circuit part drawing in experiments.

The type of the drawing is determined in order to determine the feature that is to be input to the drawing evaluation AI module 460. The determination of the type of the drawing may be performed as described below.

(1) The type of the drawing may be estimated in accordance with information included in the drawing. The information included in the drawing may include a part number, name of a part, note. The part number complies with naming convention in accordance with the type of the drawing. The type of the drawing is determined by determining whether the part number complies with the naming convention of the electrical circuit part drawing or the naming convention of the resin drawing or sheet metal drawing.

(2) The type of the drawing may be determined in accordance with the drawing information table 500 on the drawing module DB 420 (specifically the type of drawing column 506).

(3) The type of the drawing may be determined in accordance with the contents of the drawing. For example, if an element of the electrical parts, such as a resistor, is extracted through pattern matching, the drawing may be determined as the electrical circuit part drawing.

(4) The type of the drawing may be determined in accordance with the validity of a value calculated from multiple features. For example, a drawing with none of the electrical parts mounted may be possibly determined to be not an electrical circuit part drawing.

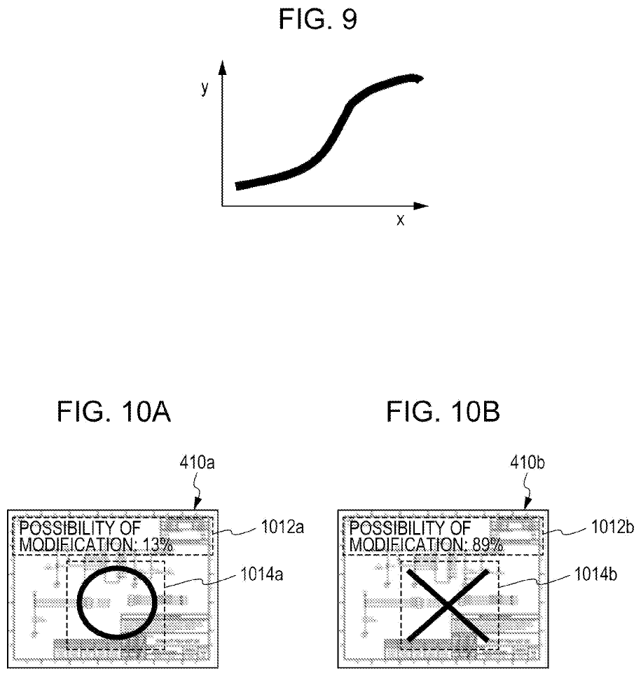

FIG. 9 is a graph illustrating a relationship between the number of NONASSYs on a drawing and the complexity of a circuit.

The drawing that has been used without modification for a long period of time has typically a higher design quality.

In the electrical circuit part drawing, an experienced design engineer typically arranges through-holes called NONASSY in a circuit diagram in order to reduce the impact of a design modification. In other words, the design engineer predicts an update possibility in the circuit. For example, if a circuit is complex or new or is intended to be used in a wide range of applications, NONASSY is arranged in the circuit diagram. On the other hand, a design intended to reduce the number of parts to reduce costs (so-called speculative design) may be used.

For example, if the number of NONASSYs is represented by the Y axis and the complexity of the circuit is represented by the X axis, an appropriate number of NONASSYs (probability density) is found in the graph in FIG. 9. If other features, such as a design period, acceptance period, and an amount of review, are constant, this graph holds true. The graph varies depending on the other features.

The complexity along the X axis in the graph in FIG. 9 is calculated as follows:

Complexity: O ((number of parts+1)×(number of wirings+1)×(number of power supplies connected+1)×(number of external wirings+1))

For example, in the drawing image 700 in FIG. 7A, the complexity is calculated as follows:

Complexity: O ((3+1)×(14+1)×(4+1)×(4+1)×(6+1))=4

If the complexity is applied to the graph in FIG. 9, the appropriate number of NONASSYs is 4 to 6. This is applicable to a new design.

Since the number of NONASSYs in the drawing image 700 in FIG. 7A is “3,” the number of NONASSYs may be increased by performing a review operation.

If the circuit of the drawing image 700 has been used in many product groups for a long period of time, the appropriate number of NONASSYs may decrease. For example, if a capacitor or the like is mounted on a portion of NONASSY, that portion is not NONASSY anymore.

FIGS. 10A and 10B illustrate a process example of the exemplary embodiment and thus an output example of the output device 470.

Referring to FIG. 10A, a drawing image 410a displays evaluation results (characters) 1012a and evaluation results (drawing) 1014a. In this example, the target drawing is evaluated to be higher in quality.

Referring to FIG. 10B, a drawing image 410b displays evaluation results (characters) 1012b and evaluation results (drawing) 1014b. In this example, the target drawing is evaluated to be lower in quality.

Evaluation results of the drawing evaluation AI module 460 indicates “possibility of modification.” Additionally or alternatively, a piece of advice, such as “This drawing is to be reviewed,” may be output by the drawing evaluation AI module 460.

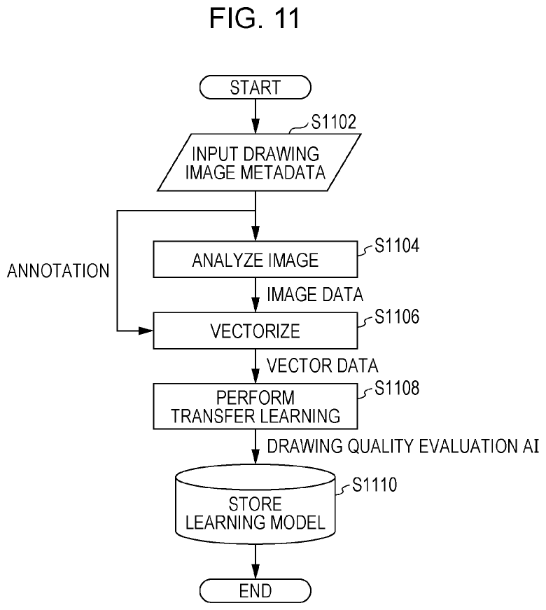

FIG. 11 is a flowchart illustrating a process example of the exemplary embodiment. In the process example, the learning module 156 creates the AI evaluation model module 152. For example, the process example is used to perform machine learning on a resin drawing by using results of machine learning of an electrical circuit drawing.

In step S1102, metadata on a drawing image is input. The metadata herein includes evaluation results.

In step S1104, an image is analyzed.

In step S1106, the vectorization operation is performed. Operations in steps S1104 and S1106 are respectively identical to those in steps S306 and S308 in the flowchart in FIG. 3.

In step S1108, transfer learning is performed. The transfer learning is one type of machine learning. As previously described, machine learning is performed by applying the knowledge of a learning model (such as the AI evaluation model module 152) having performed machine learning and a new learning model is created.

In step S1110, the learning model is stored.

The program described above may be provided in a recorded form on a recording medium or via a communication medium. The program described above may be construed as a computer readable non-transitory recording medium storing the program.

The non-transitory computer readable medium recording the program refers to as a recording medium that is used to install, execute, and/or distribute the program.

The recording media include digital versatile disk (DVD), compact disk (CD), Blu-ray disc (registered trademark), magnetooptical disk (MO), flexible disk (FD), magnetic tape, hard disk, read-only memory (ROM), electronically erasable and programmable read-only memory (EEPROM (registered trademark)), flash memory, random-access memory (RAM), and secure digital (SD) memory card. The DVDs include “DVD-R, DVD-RW, and DVD-RAM” complying with the standard formulated by the DVD forum, and “DVD+R and DVD+RW” complying with DVD+RW standards. The CDs include read-only CD (CD-ROM), recordable CD-R, and rewritable CD-RW.

The program in whole or in part may be stored on the recording medium for storage and distribution. The program in whole or in part may be transmitted via a transmission medium. The transmission media include a wired network, a wireless network, or a combination thereof. The wired and wireless networks may include a local-area network (LAN), metropolitan-area network (MAN), wide-area network (WAN), the Internet, intranet, and/or extranet. The program in whole or in part may be transmitted over a carrier wave.

The program may be part or whole of another program, or may be stored on the recording medium together with another program. The program may be split and the split programs may then be separately stored on the recording media. The program may be processed in any fashion before being stored as long as the program remains restorable. For example, the program may be compressed or encrypted before storage.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory storing, in an associated form, part identification information and information on at least one drawing; and
a processor configured to
receive an image of a drawing,
read part identification information from the image,
retrieve from the memory the information on the at least one drawing associated with the part identification information read from the image,
extract a feature from the image,
evaluate a quality of the received drawing by inputting the extracted information on the at least one drawing and the feature to artificial intelligence that has learned to evaluate drawings through machine learning, and
display evaluation results of the received drawing on a display.

2. The information processing apparatus according to claim 1, wherein the memory stores, as the information on the at least one drawing, information indicating the quality of the at least one drawing.

3. The information processing apparatus according to claim 2, wherein the memory stores, as the information indicating the quality of the at least one drawing, at least one piece of information selected from a group including a version number of the at least one drawing, a number of persons who have checked the at least one drawing, a number of days from a start of development of the at least one drawing to an end of a check of the at least one drawing, and a degree of importance of the at least one drawing.

4. The information processing apparatus according to claim 1, wherein the processor is configured to extract at least one piece of information selected from a group including a part name, a sheet number, a number of sheets, and a number of approvers.

5. The information processing apparatus according to claim 4, wherein the processor is configured to extract the feature from the image of the received drawing after deleting information other than on a part from the received drawing.

6. The information processing apparatus according to claim 5, wherein the received drawing is an electrical circuit part drawing, and
wherein the processor is configured to extract, as the feature to be extracted from the image, at least one piece of information selected from a group including a notation indicating acceptability of future mounting and information on an electrical part.

7. The information processing apparatus according to claim 1, wherein the processor is configured to extract as the feature an image that results from performing on the received image a pre-process to delete an unwanted element.

8. The information processing apparatus according to claim 2, wherein the processor is configured to extract as the feature an image that results from performing on the received image a pre-process to delete an unwanted element.

9. The information processing apparatus according to claim 3, wherein the processor is configured to extract as the feature an image that results from performing on the received image a pre-process to delete an unwanted element.

10. The information processing apparatus according to claim 4, wherein the processor is configured to extract as the feature an image that results from performing on the received image a pre-process to delete an unwanted element.

11. The information processing apparatus according to claim 5, wherein the processor is configured to extract as the feature an image that results from performing on the received image a pre-process to delete an unwanted element.

12. The information processing apparatus according to claim 6, wherein the processor is configured to extract as the feature an image that results from performing on the received image a pre-process to delete an unwanted element.

13. The information processing apparatus according to claim 7, wherein the processor is configured to, if the received image is a resin drawing or a sheet metal drawing, normalize the received image of the drawing in the pre-process.

14. The information processing apparatus according to claim 8, wherein the processor is configured to, if the received image is a resin drawing or a sheet metal drawing, normalize the received image of the drawing in the pre-process.

15. The information processing apparatus according to claim 9, wherein the processor is configured to, if the received image is a resin drawing or a sheet metal drawing, normalize the received image of the drawing in the pre-process.

16. The information processing apparatus according to claim 10, wherein the processor is configured to, if the received image is a resin drawing or a sheet metal drawing, normalize the received image of the drawing in the pre-process.

17. The information processing apparatus according to claim 11, wherein the processor is configured to, if the received image is a resin drawing or a sheet metal drawing, normalize the received image of the drawing in the pre-process.

18. The information processing apparatus according to claim 12, wherein the processor is configured to, if the received image is a resin drawing or a sheet metal drawing, normalize the received image of the drawing in the pre-process.

19. The information processing apparatus according to claim 1, wherein the processor is configured to extract from the received image, as the feature, information described in the received image determined in accordance with the information on the at least one drawing.

20. A non-transitory computer readable medium storing a program causing a computer to execute a process for processing information, the process comprising:
storing, in an associated form, part identification information and information on at least one drawing;
receiving an image of a drawing,
reading part identification information from the image,
retrieving from the memory the information on the at least one drawing associated with the part identification information read from the image,
extracting a feature from the image,
evaluating a quality of the received drawing by inputting the extracted information on the at least one drawing and the feature to artificial intelligence that has learned to evaluate drawings through machine learning, and
displaying evaluation results of the received drawing on a display.
